(19) United States
(12) Patent Application Publication
(10) Pub. No.: US 2012/0023819 A1
(43) Pub. Date: Feb. 2, 2012

(54) Lantern planter

(76) Inventor: Tamara Marano, Fort Wayne, IN (US)

(21) Appl. No.: 12/804,742

(22) Filed: Jul. 28, 2010

(51) Int. Cl. A01G 9/02

(52) U.S. Cl. 47/65.7; 47/65.5; 47/66.6

(57) ABSTRACT

A lantern planter wherein an exterior vessel contains inside of it an interior vessel. The interior vessel contains an interior fill material utilized to create mass inside the present invention. Affixed atop the interior vessel is a post support collar used to provide support to a post that is used to provide vertical support and stability to a supported device mechanically fastened to the post. The interior vessel, once filled with the interior fill material, and after the post is inserted via the post support collar has exterior fill material and decorative material installed atop the interior vessel such that the lantern planter provides structural support for the supported device and is aesthetically pleasing to the user.

### CROSS-REFERENCE TO RELATED APPLICATIONS

This is a non-provisional patent application bearing the title “LANTERN PLANTER” filed on Jul. 28, 2010.

### BACKGROUND OF THE INVENTION

1. Field of the Invention

The present invention relates to planter vessel, and more particularly a planter vessel that has been constructed to provide stability and support to various outdoor decorative objects that the user would operate to provide luminescence and decorative design elements in and throughout their living spaces.

2. Description of the Related Art

There are numerous planter vessels and support structures available in the market that only serve a solitary function, i.e. to either act as a planter for various types of flora, or to serve as a mounting point on a solid-surface landscaping element such as concrete, pavement, or landscaping timbers and is used to support a lighting device affixed to a pole or hanger. With the economy in the state that it is, people are spending more money improving their living conditions and the aesthetic appeal of their outdoor living environments. With these improvements, people are spending more recreation time in those improved living areas and the rise in this leisure activity has coined the phrase, “stay-cation.” With increased time, people desire to have products that can support a variety of uses and provide value for their dollar.

Current planter vessels are manufactured in a variety of different sizes, shapes, textures, materials and colors. They are typically filled with a planting material that then has inserted into it natural or synthetic flora of different species. In the bottom of the planter vessel there is typically a plurality of holes used for drainage of excess water from the planter vessel. The drainage hole(s) provide an outlet for excess water and an inlet for air circulation amongst the flora's roots.

Current support structures that are available in the market that support lighting devices are typically those associated as being stake-like and are meant to be inserted into the landscaping. Support structures of this sort are problematic in that they are easily dislodged due to natural environmental elements, people and animals traversing by the support and making contact with the same and knocking the support askew. There are also available support structures that are meant to be permanently affixed to solid-surface landscaping elements that utilize a plurality of mechanical fasteners to affix the same to the landscaping element. The problem associated with these types of support structures is that they cannot be easily moved around to accommodate changing season conditions, activities of the user such as hosting parties, games and other outdoor events, without leaving holes in the solid-surface landscaping element from the removal of the mechanical fasteners.

What is needed in the art is a planter vessel that serves not only as a vessel to support flora but can also be utilized to support various styles of illumination and other devices.

### SUMMARY OF THE INVENTION

The present invention provides a planter vessel that serves as a flora holder and as a support base for illumination and other devices.

The invention comprises, in one form thereof, an exterior vessel that is formed in such a manner as to incorporate an aesthetically pleasing design, texture, and material that the user selects to improve the aesthetics of their outdoor living conditions. Located on the interior of the outside vessel is an interior vessel. The interior vessel contains several important features. The first feature is that there is at least one hole that is employed by the user to insert a fill material such as soil, sand, plaster, concrete, or a liquid such as water. These types of fill materials are used to provide structural mass for the planter vessel to not only support the planter vessel from tipping over, but to also provide enough mass as to provide structural support for an illumination or other device affixed atop the planter vessel.

Atop the interior vessel there is a post hole for the user to insert a post support collar that is designed in such a manner as to accommodate a wide-variety of different styles of post cross-sectional areas such as square, circular, or oval. The post support collar supports the post that is attached to the illumination or other device and this post is used to elevate the illumination or other device above the planter vessel. The interior fill material does not make contact with the post nor the post support collar so that when the user decides to exchange posts in the lantern planter, the post can easily be inserted and removed utilizing the post support collar without having to empty the interior vessel of the fill material.

Once the interior vessel has been inserted into the planter vessel and has been filled with the interior fill material, either prior to insertion or after insertion, selected by the user, the post can then be inserted into the post support collar that has been inserted into the post hole and is held into the post hole by a friction fit. The post hole collar contains at least one threaded fastener that is utilized by the user to secure the post into the post support collar. Once this has been accomplished, the user can then fill the present invention with an exterior fill material of their choosing such as soil, sand or rocks and insert into that material, the decorative material of their choosing such as natural flora, silk flora, or other aesthetically-pleasing items. The exterior fill material and the decorative material may also provide structural support for the post once installed into the post support collar, dependent upon what materials are selected by the user.

After the post has been installed, the user can then affix atop the post the illumination or other device of their choosing. The present invention supports a wide-variety of illumination devices such as solar-powered lanterns, hydrocarbon fuel lanterns, candle lanterns, or other non-illumination devices such as rope holders, drink holders, cigarette butt holders, sign holders, or umbrellas.

One advantage of the present invention is that the planter vessel can accommodate different styles of illumination devices that can be easily changed by the user. The user can select a solar-powered device for one type of outdoor event or pick a hydrocarbon fuel type device for purposes of providing illumination and insect repellant. Or depending on the application of the user, an illumination device that has a candle installed could be very desirable by the user.

Yet another advantage of the present invention is the planter vessel can be easily moved around the outdoor living area by the user. This allows the user to accommodate changing natural lighting conditions as the seasons change. The user can also move the planter vessel around to accommodate different life activities such as dances, outdoor dining, game playing, and other activities that would be improved by better lighting.

Yet another advantage of the present invention is that the planter vessel can have the illumination device removed altogether and have another device affixed atop the pole. These devices could include a rope holder for purposes that a plurality of planter vessels could be organized so that when the rope holder is affixed atop the post and a rope is installed, the user constructs a cordoned off area or directs human traffic flow for outdoor life activities that call for such control. Besides the rope holder, a drink holder could be affixed such that multiple users could place their beverages atop the drink holder. This allows the planter vessel to be a very useful accessory for the user when they are hosting parties. Besides the drink holder, a sign holder can be installed by the user that would hold a variety of different placard-style signs that would provide information to users and their guests. In addition, the sign holder can be replaced with a cigarette butt holder that the user, or their guests, can use to properly dispose of their cigarette butts and ashes instead of displacing the waste onto the user's landscape surfaces. Lastly, the user can install atop the post an umbrella that can provide shading for the user, the user's guests, and/or pets.

Yet another advantage of the present invention is that the lantern planter can be made in a wide-range of styles and sizes such that the lantern planter could be placed atop a landscaping surface or atop a table. This particular feature of the present invention provides more diversity in the available applications of the present invention.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a perspective view of the exterior vessel and installed decorative material utilized in the preferred embodiment of the present invention; and

FIG. 2 illustrates a perspective view of the interior vessel utilized in the preferred embodiment of the present invention; and

FIG. 3 illustrates a perspective view of the supported device utilized in the preferred embodiment of the present invention; and

FIG. 4 illustrates a perspective view of the post utilized in the preferred embodiment of the present invention; and

FIG. 5 illustrates a perspective view of the post support collar utilized in the preferred embodiment of the present invention; and

FIG. 6 illustrates a top-end view of the exterior vessel utilized in the preferred embodiment of the present invention; and

FIG. 7 illustrates a top-end view of the interior vessel utilized in the preferred embodiment of the present invention; and

FIG. 8 illustrates a perspective view of the preferred embodiment of the present invention.

FIG. 9 illustrates a perspective view of a second embodiment of the external vessel contained in the present invention.

FIG. 10 illustrates a perspective view of a third embodiment of the present invention.

FIG. 11 illustrates a perspective view of a fourth embodiment of the external vessel contained in the present invention.

FIG. 12 illustrates a perspective view of a second embodiment of the supported device, namely a rope holder.

FIG. 13 illustrates a perspective view of a third embodiment of the supported device, namely a drink holder.

FIG. 14 illustrates a perspective view of a fourth embodiment of the supported device, namely a cigarette holder.

FIG. 15 illustrates a perspective view of a fifth embodiment of the supported device, namely a sign holder.

FIG. 16 illustrates a perspective view of a sixth embodiment of the supported device, namely an umbrella.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION OF THE PRESENT INVENTION

Referring now to the drawings, and, more particularly to FIG. 1, the preferred embodiment of the present invention is a lantern planter 2 that comprises an exterior vessel 4 that contains a first end and a second end. The first end of the exterior vessel 4 is placed atop a landscaping surface 30. Placed onto the second end of the exterior vessel 4 is a decorative material 28. The exterior vessel 4 contains a centerline a that runs substantially perpendicular to the landscaping surface 30 and through the center point of the first end of the exterior vessel 4 and the center point of the second end of the exterior vessel 4.

In addition, the height of the exterior vessel 4, without the decorative material 28 installed is A′. The measurement of A′ can be of varying distances, but it is envisioned that the measurement of A′ would be such that it would produce an ideal aesthetic appeal of the exterior vessel 4 when utilized in the lantern planter 2.

The preferred embodiment of the present invention shows the exterior vessel having four walls. This would produce a cross-sectional area of the exterior vessel 4 that would be rectangular or square in shape when the exterior vessel 4 is dissected by a plane of reference taken from a plane substantially perpendicular to the surface of the landscaping material 30 and dissecting the exterior vessel 4.

It is envisioned that another embodiment of the present invention would be such that the exterior vessel 4 could be formed in such a manner that it would contain only one wall that would produce a cross-sectional area of the exterior vessel 4 that would be circular, or ovular, when the exterior vessel 4 is dissected by a plane of reference taken from a plane substantially perpendicular to the surface of the landscaping material 30. Other embodiments of the present invention would be such that exterior vessel 4 could contain a plurality of walls that would produce multiple varieties of cross-sectional areas of the exterior vessel 4 dependent upon how many walls makeup the exterior vessel 4.

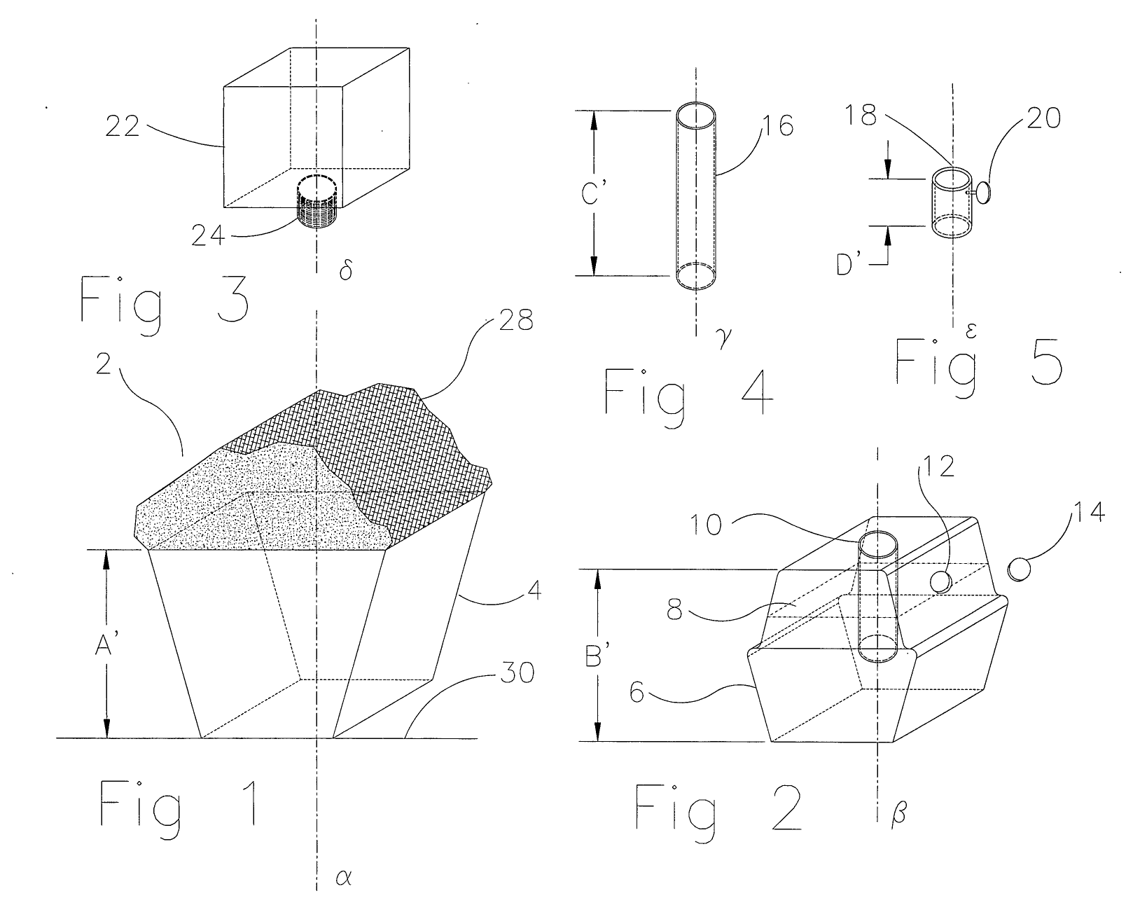

Now additionally referring to FIG. 2, a perspective view of an interior vessel 6, having a first end and a second end, contains at least one of a fill hole 12 that traverses through the wall of the interior vessel 6. The interior vessel 6 contains a centerline β that runs substantially perpendicular to the landscaping surface 30 and runs through the center point of the first end of the interior vessel 6 and the center point of the second end of the interior vessel 6. In addition, when the interior vessel 6 is installed into the exterior vessel 4, the centerline β runs inline with, and parallel to, the centerline α.

The fill hole 12 allows the user to introduce an interior fill material 8 into the inside cavity of the interior vessel 6. The interior fill material 8 can be of a substance such as water, sand, plaster, concrete or other viscous-like material that adds mass to the interior vessel 6. The purpose of this mass is to add weight to the base of the lantern planter 2 for purposes of adding stability to the lantern planter 2 to prevent the lantern planter 2 from being knocked over from natural elements, humans, or animals traversing around the lantern planter 2. The fill hole 12 has a fill hole cap 14 that is installed by the user after the interior fill material 8 is introduced into the interior vessel 6 by the user. The fill hole cap 14 can take many different shapes, but the preferred embodiment is that of a cap being a bung-style plug that would be retained into the fill hole 12 by friction-fit between the fill hole cap 14 and the fill hole 12. The first end of the interior vessel 6 is placed adjacent, and atop to, the first end of the exterior vessel 4. The fill hole 12 is located in the immediate vicinity of the second end of the interior vessel 6. On the second end of the interior vessel 6, immediately opposite to the first end of the interior vessel 6, is a post hole 10. The post hole 10 is cylindrical and is in such a configuration as to allow a post support collar 18, and through it, a post 16, to be inserted into the interior vessel 6 without the post 16, or the post support collar 18, making contact with the interior fill material 8. The interaction of the post support collar 18 and the post 16 will be explained in further detail in later figures.

Still referring to FIG. 2, the half of the interior vessel 6 that contains the fill hole 12 has at least one exterior wall that tapers inward toward the second end of the interior vessel 6. The purpose of this design is to allow an exterior fill material 26 to be installed by the user after the interior vessel 6 is installed into the lantern planter 2 with the post 16 inserted into the post support collar 18 that has been inserted into the second end of the post hole 10 contained in the second end of the interior vessel 6. The inward taper of the interior vessel 6 allows additional exterior fill material 26 to be installed by the user. The exterior fill material 26 can be of many different materials such as soil, sand, rocks, or other natural materials. It is envisioned that the preferred embodiment of the present invention would utilize the exterior fill material 26 that would be potting soil. The insertion of the interior vessel 6 into the exterior vessel 4, combined with the inward taper of at least one of the sidewalls of the interior vessel 6 produces a plurality of benefits for the user. The first benefit is that it eliminates the necessity of having drain holes located on the first end of the exterior vessel 4 for purposes of allowing excess water to exit the planter. With the present invention, there is room for excess water to collect between the walls of the exterior vessel 4 and the interior vessel 6. The second benefit is that it produces a shallower bed for the exterior fill material 26 that allows for better air circulation and irrigation of the root system of any biomass utilized in the decorative material 28 than what is typically found in a normal planter.

In addition, the height of the interior vessel 6, as measured by B′, can be of varying distances, but it is envisioned that the measurement of B′ would be such that it would produce an ideal bed-depth for the exterior fill material 26 that would produce the previously described benefits while also creating enough mass inside of the interior vessel 6 to prevent the lantern planter 2 from being knocked over as previously discussed.

Now additionally referring to FIG. 3, what is shown is a supported device 22 having a first end and a second end and contains a centerline δ that is located through the center point of the first end of the supported device 22 and the center point of the second end of the supported device 22 and runs substantially perpendicular to the landscaping surface 30 when installed onto the lantern planter 2 and inline and parallel with the centerline α and the centerline β. Located on the first end of the supported device 22 is a supported device hole 24. The supported device 22 is installed onto the lantern planter 2 by inserting the second end of the post 16 into the supported device hole 24. The means for mechanically fastening the supported device 22 to the post 16 can include, but is not limited to, a male and female thread assembly, thumbscrews inserted into the supported device hole 24 that apply mechanical pressure onto the second end of the post 16, or a clip-type fastening system contained inside the supported device hole 24 and the second end of the post 16 that allows the user to apply pressure to a pre-formed tabular component. The purpose for this type of mechanical fastening system is to allow the user to be able to easily change the supported device 22 to a different style of the supported device 22. It is envisioned that the preferred embodiment of the present invention would be such to utilize a male and female thread assembly for purposes of allowing easy installation and removal of the supported device 22 by the user while providing optimal structural stability. The supported device 22 can be of a type that includes, but is not limited to, a solar-powered lantern, a hydrocarbon fuel lantern, a candle lantern, an incandescent lamp holder, a rope holder, a drink holder, a cigarette butt holder, a sign holder, or umbrella.

Now additionally referring to FIG. 4, what is shown is a perspective view of the post 16, having a first end and a second end. The post 16 also contains a centerline γ that runs substantially parallel to the longitudinal axis of the post 16 and runs through the center point of the first end of the post 16 and the center point of the second end of the post 16 and parallel and in line with the centerline α, the centerline β, and the centerline δ when installed into the post support collar 18 that is installed into the post hole 10 located in the interior vessel 6 and the interior vessel 6 is installed into the exterior vessel 4. The cross-sectional area of the post 16, taken by dissecting a plane of reference substantially parallel to both the first end of the post 16 and the second end of the post 16 and would produce a variety of shapes that would include a circle, square, rectangle, oval, star and triangular. In addition, the exterior walls of the post 16 can be formed in such a manner as to produce a taper from the first end of the post 16 towards the second end of the post 16, or produce a taper from the second end of the post 16 towards the first end of the post 16 or some combination of tapers and profile that produces an aesthetic appeal of the post 16. It is envisioned that the preferred embodiment of the present invention would be such that post 16 would be of such a manner as to be a hollow, cylindrical post, but the post 16 could be a solid post dependent upon what is installed onto the second end of the post 16.

In addition, the length of the post 16 is measured by C′. The measurement of C′ can be of varying distances, but it is envisioned that the measurement of C′ would be such that it would produce an ideal aesthetic appeal between the relationship between the supported device 22 installed onto the second end of the post 16 and the decorative material 28 and would produce the desired effects previously discussed when the lantern planter 2 is utilized by the user.

Now additionally referring to FIG. 5, what is shown is the post support collar 18. The post support collar 18 has a first end and a second end. The length of the post support collar 18 is D′. The post support collar 18 also contains a centerline E that runs substantially parallel to the longitudinal axis of the post support collar 18 and runs through the center point of the first end of the post support collar 18 and the center point of the second end of the post support collar 18 and parallel and in line with the centerline α, the centerline β, the centerline δ, and the centerline δ when the entirety of the lantern planter 2 is assembled

The cross-sectional area of the post support collar 18, taken by dissecting a plane of reference substantially parallel to both the first end of the post support collar 18 and the second end of the post support collar 18 and would produce an area that is circular in nature. The cross-sectional area of the post support collar 18 is smaller at the first end of the post support collar 18 and increases along D′ towards the approximate midpoint of D′ and produces what is commonly referred to as a taper. The first end of the post support collar 18 is inserted into the post hole 10 up to a point as to produce a friction fit between the sidewalls of the post support collar 18 and the post hole 10 so that the post support collar 18 is held into the post hole 10, with the characteristics of the post hole 10 being described in further detail later.

The portion of the post support collar 18 running from the approximate midpoint of D′ to the second end of the post support collar 18 contains at least one of a post support collar pin 20. The post support collar pin 20 traverses through the sidewall of the post support collar 18 and is to threaded through the sidewall of the post support collar 18. The post support collar pin 20 is utilized by the user of the present invention to apply pressure to the sidewall of the post 16 and rigidly contain the post 16 into the post support collar 18. The cross-sectional area of the post support collar 18 is such a size to accommodate the variety of cross-sectional areas of the post 16 as previously discussed that is inserted into the post support collar 18. The requisite number of post support collar pin 20 is also determined by the type of post 16 needed to be supported by the post support collar 18.

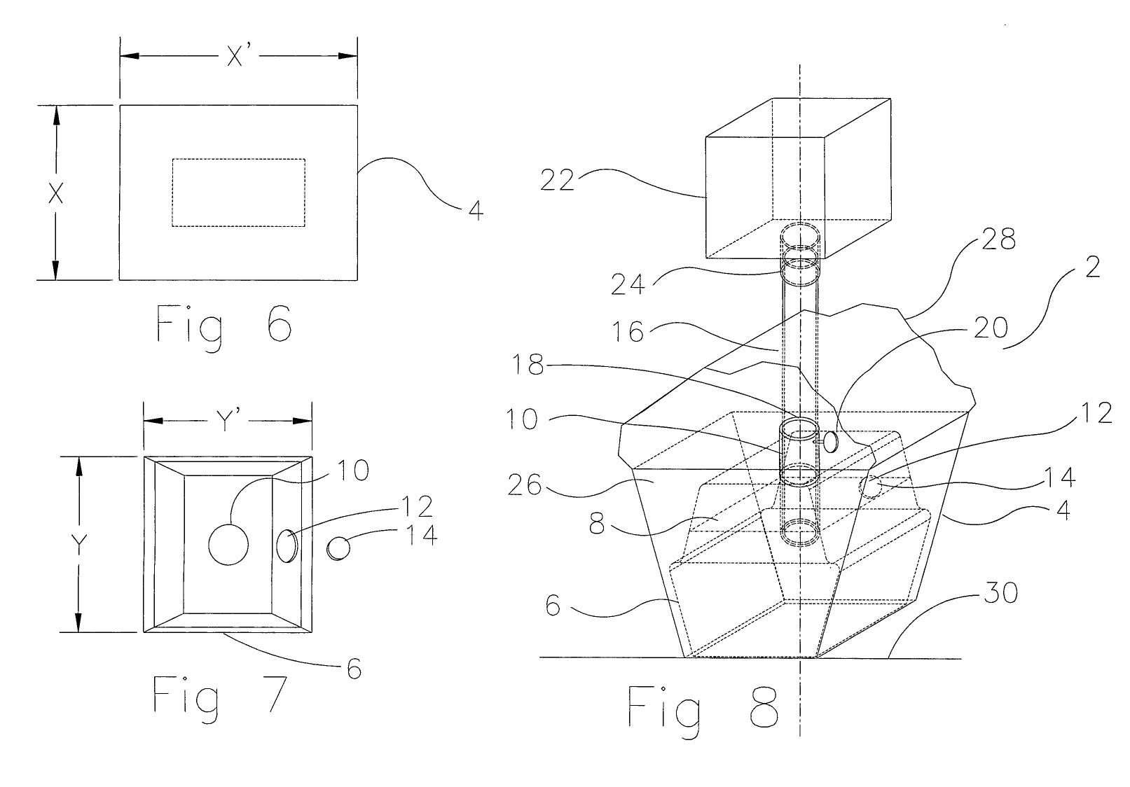

Now additionally referring to FIG. 6, what is shown is a top-end view of the exterior vessel 4 that has a width of X′ and a depth of X. It is envisioned that the preferred embodiment of the present invention would be such that X′ and X could be of non-equivalent lengths producing a cross-sectional area that is commonly referred to as a rectangle, or X′ and X can be equivalent lengths producing a cross-sectional area that is commonly referred to as a square, or of X′ and X can be of such lengths that when radiated around the center line a of the exterior vessel 4, produces a cross-sectional area that is commonly referred to as a cylinder, or X′ and X can be of non-equivalent lengths that when radiated around the center line α, produce a cross-sectional shape commonly referred to as an oval. The lengths of X′ and X can also vary in length over the distance spanned by the first end of the exterior vessel 4 and the second end of the exterior vessel 4 producing what is commonly associated as a taper of the sidewalls of the exterior vessel 4. This taper is created by having X′ and X smaller at the first end of the exterior vessel 4 and increasing the distance of X′ and X as the measurement moves along the centerline a towards the second end of the exterior vessel 4.

It is necessary that the distances of X′ and X, when measured at the first end of the exterior vessel 4 to be smaller than when X′ and X are measured at the second end of the exterior vessel 4 thus producing an outward taper away from the centerline a This is important so that the user can install the interior vessel 6 into the interior of the exterior vessel 4.

Now additionally referring to FIG. 7, what is shown is a top-end view of the interior vessel 6 that has a width of Y′ and a depth of Y. It is envisioned that the preferred embodiment of the present invention would be such that Y′ and Y could be of non-equivalent lengths producing a cross-sectional area that is commonly referred to as a rectangle, or Y′ and Y can be of equivalent lengths producing a cross-sectional area that is commonly referred to as a square, or Y′ and Y can be of such lengths that when radiated around the center line β of the interior vessel 6, produces a cross-sectional area that is commonly referred to as a cylinder, or Y′ and Y can be of non-equivalent lengths that when radiated around the center line β of the interior vessel 6, produce a cross-sectional shape commonly referred to as an oval.

The lengths of Y′ and Y can also vary in length over the distance spanned by the midpoint of B′ to the second end of the interior vessel 6 producing what is commonly associated as an inwards taper of the sidewalls of the interior vessel 6 that slant towards the second end of the interior vessel 6. This taper is created by having Y′ and Y larger at the midpoint of B′ of the interior vessel 6 and decreasing the distance of Y′ and Y as the measurement moves along the centerline β towards the second end of the interior vessel 6.

The lengths of Y′ and Y can also vary in length over the distance spanned by the first end of the interior vessel 6 to the midpoint of B′ producing what is commonly associated as an outwards taper of the sidewalls of the interior vessel 6. This would be done for purposes of matching the profile of the exterior vessel 4.

In order for the interior vessel 6 to fit inside of the exterior vessel 4, it is necessary that the distances of Y′ and Y, when measured at a point along the centerline β of the interior vessel 6 be smaller than the distances of X′ and X, when taken at the equivalent measurement point along the centerline α of the exterior vessel 4.

Still referring to FIG. 7, located atop the second end of the interior vessel 4 is the post hole 10. The center point of the post hole 10 is located on the centerline β and created by the formation of a cylindrical depression with a longitudinal axis running substantially parallel and inline with centerline β and starting at the second end of the interior vessel 6 and extending towards the first end of the interior vessel 6. The preferred embodiment of the present invention in relation to the post hole 10 would be that post hole 10 would have a length sufficient to support the insertion of the post support collar 18 that provides stability to the post 16 when the supported device 22 is installed atop the post 16, but not traverse completely through the interior vessel 6. It would be possible for an alternative embodiment of the interior vessel 6 to have the post hole 10 that traversed completely through the interior vessel 6 and would have an opening on the first end of the interior vessel 6 and the second end of the interior vessel 6, but this would take away volume from the interior of vessel 6 and would decrease the amount of interior fill material 8 that could be installed by the user. The post 16 also may garner additional stability support by the pressure exerted onto the exterior surface of post 16 by the exterior fill material 26 and the decorative material 28 installed atop of the second end of the interior vessel 6, dependent upon the materials selected by the user.

Now additionally referring to FIG. 8, what is shown is a perspective view of the preferred embodiment of the present invention and shows the assembled lantern planter 2. Located on the interior of the exterior vessel 4 is the interior vessel 6 sitting atop the first end of the exterior vessel 4. Inside the interior vessel 6 is the interior fill material 8 that provides mass to the lantern planter 2 and prevents tipping of the lantern planter 2. The post 16 has been inserted into the post support collar 18 that is inserted into the post hole 10 that is located atop the second end of the interior vessel 6. Installed into the interior vessel 4 is the fill hole cap 14 that has been installed into the fill hole 12 that now contains the interior fill material 8 into the interior of the interior vessel 6. Located on and mechanically affixed to the second end of the post 16 is the supported device 22 that contains on the first end of the supported device 22, the support device hole 24 that contains the means for mechanically fastening the supported device 22 to the second end of the post 16. Installed into the lantern planter 2 is the exterior fill material 26 that sits atop the second end of the interior vessel 6 and also provides mass to the lantern planter 2 to prevent tipping and may aid in the support of the post 16 installed into the post support collar 18. Installed into the exterior fill material 26 is the decorative material 28. Lastly, the lantern planter 2 sits atop the landscaping surface 30.

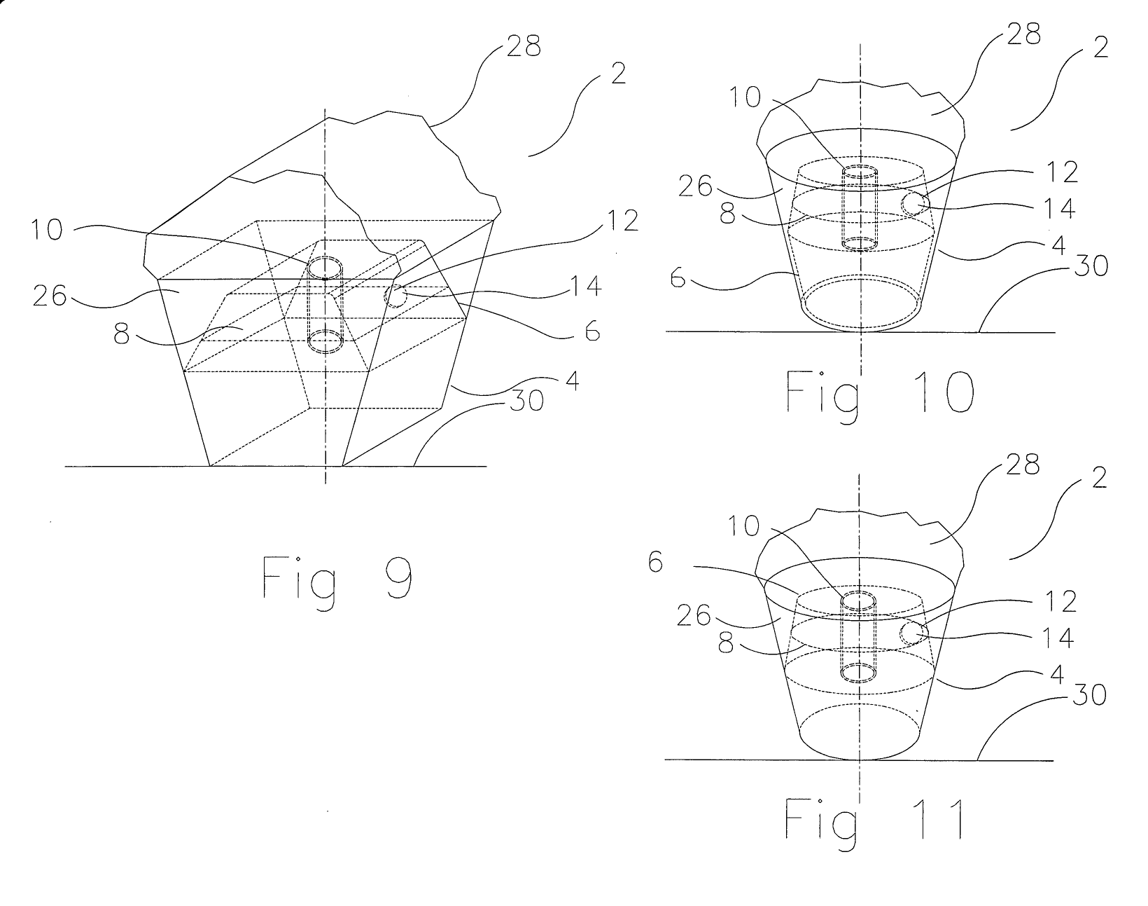

Now additionally referring to FIG. 9, what is shown is a perspective view of a second embodiment of the present invention, namely the exterior vessel 4 and the interior vessel 6 are constructed in a manner that they are a unified piece instead of having a separate exterior vessel 4 and interior vessel 6. An interior vessel 6 is created in the interior of the exterior vessel 4 and holds the interior fill material 8. Traversing through the second end of the interior vessel 6 through the center point of the second end of the exterior vessel 4 is the post hole 10 containing the same characteristics as demonstrated and discussed in the preferred embodiment of the present invention. Also contained in the interior vessel wall is the fill hole 12 and fill hole cap 14 containing the same characteristics as demonstrated and discussed in the preferred embodiment of the present invention. Atop the second end of the interior vessel 6 is the exterior fill material 26 and atop that is the decorative material 28. This second alternative embodiment of the present invention can be placed atop landscaping surface 30 or on a tabletop as previously discussed.

Now additionally referring to FIG. 10, what is shown is a perspective view of a third embodiment of the present invention namely that the exterior vessel 4 and the interior vessel 6 are two separate pieces as previously discussed. The shape of the exterior vessel 4 and the interior vessel 6 are distinctly conical in shape with the first end of the external vessel 4 having a smaller cross-sectional area than the second end of the external vessel 4. Likewise, the first end of the internal vessel 6 has a smaller cross-sectional area than the second end of the internal vessel 6.

Now additionally referring to FIG. 11, what is shown is a perspective view of a fourth embodiment of the present invention in that there is a unified configuration of the external vessel 4 and internal vessel 6, as demonstrated and discussed for the second embodiment of the present invention and shown in FIG. 9. This embodiment takes on a shape of that being conical having the same characteristics as demonstrated and discussed previously and shown in FIG. 10.

Now additionally referring to FIG. 12, what is shown is a second embodiment of the supported device 22. In this embodiment, the user installs the supported device 22 atop the second end of the post 16 via the support device hole 24 located on the first end of the supported device 22. There is provided on the second end of the supported device 22 a rope holder 32 so that an apparatus such as a cord, rope, hose or other object for purposes of creating a dividing obstacle or barrier, can be directed through the rope holder 32.

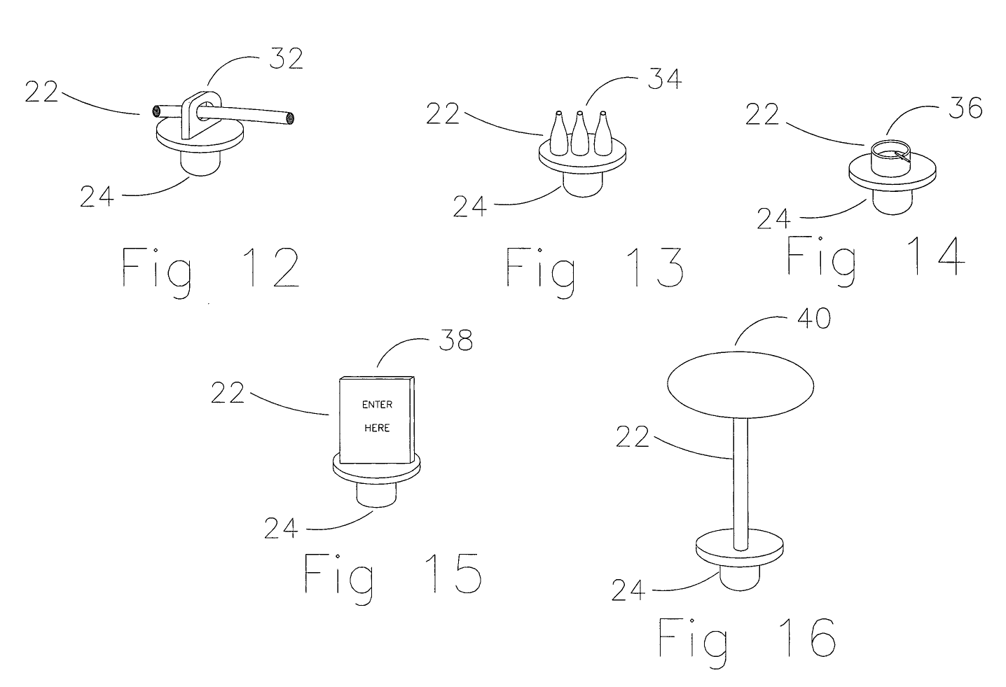

Now additionally referring to FIG. 13, what is shown is a third embodiment of the supported device 22. In this embodiment, the user installs the supported device 22 atop the second end of the post 16 via the support device hole 24 located on the first end of the supported device 22. There is provided on the second end of the supported device 22 a drink holder 34 so that one or more liquid-containing containers can be supported by the supported device 22.

Now additionally referring to FIG. 14, what is shown is a fourth embodiment of the supported device 22. In this embodiment, the user installs the supported device 22 atop the second end of the post 16 via the support device hole 24 located on the first end of the supported device 22. There is provided on the second end of the supported device 22 a cigarette butt holder 36 so that one or more tobacco-related items can be placed into the cigarette butt holder 36 while being consumed/enjoyed by the user.

Now additionally referring to FIG. 15, what is shown is a fifth embodiment of the supported device 22. In this embodiment, the user installs the supported device 22 atop the second end of the post 16 via the support device hole 24 located on the first end of the supported device 22. There is provided on the second end of the supported device 22 a sign holder 38 that contains a means for attaching a sign selected by the user.

Now additionally referring to FIG. 16, what is shown is a sixth embodiment of the supported device 22. In this embodiment, the user installs the supported device 22 atop the second end of the post 16 via the support device hole 24 located on the first end of the supported device 22. There is provided on the second end of the supported device 22 an umbrella 40 arranged in such a manner so that the benefits of the umbrella can be enjoyed by the user.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains, and to which the claims are directed.

I claim:

1. A lantern planter comprising:
an exterior vessel;
an interior vessel;
a post;
a supported device;
an interior fill material;
an exterior fill material; and
a decorative fill material.

2. The lantern planter of claim 1, wherein the exterior vessel is made from a material selected from a group consisting of plastic, wood, stone, iron, steel, aluminum, clay, porcelain, or combinations thereof.

3. The lantern planter of claim 1, wherein the interior vessel is made from a material selected from a group consisting of plastic, wood, stone, iron, steel, aluminum, clay, porcelain, or combinations thereof.

4. The lantern planter of claim 1, wherein the post is made from a material selected from a group consisting of plastic, wood, stone, iron, steel, aluminum, clay, porcelain, or combinations thereof.

5. The lantern planter of claim 1, wherein the supported device is selected from a group consisting of a solar-powered lantern, a hydrocarbon fuel lantern, a candle-powered lantern, an incandescent lamp holder, a rope holder, a drink holder, a cigarette butt holder, a sign holder, an umbrella, or combinations thereof.

6. The lantern planter of claim 1, wherein the interior fill material is a material selected from a group consisting of soil, sand, water, plaster, concrete, or combinations thereof.

7. The lantern planter of claim 1, wherein the exterior fill material is a material selected from a group consisting of soil, sand, rocks, or combinations thereof.

8. The lantern planter of claim 1, wherein the decorative plant material is a material selected from a group consisting of natural flora, artificial flora, rocks, or combinations thereof.

9. The lantern planter of claim 1, wherein the interior vessel is located in the interior cavity of the exterior vessel.

10. The lantern planter of claim 1, wherein the supported device is mechanically attached to the post.

11. The lantern planter of claim 1, wherein the post is inserted into the interior vessel.

12. The lantern planter of claim 1, wherein the interior fill material is located in the interior of the interior vessel.

13. The lantern planter of claim 1, wherein the exterior fill material is located atop the interior vessel and inside the exterior vessel.

14. The lantern planter of claim 1, wherein the decorative material is located atop the exterior fill material.

15. A lantern support comprising:
an exterior vessel;
an interior vessel;
a post;
a post support collar;
a lantern;
an interior fill material;
an exterior fill material; and
a decorative fill material.

16. A device for supporting lanterns, the device comprising:
an interior vessel manufactured from a material comprising plastic;
an exterior vessel manufactured from a material comprising plastic;
a post manufactured from a material comprising plastic;
a post support collar manufactured from a material comprising plastic;
a supported device selected from a group consisting of solar-powered lantern, a hydrocarbon fuel lantern, a candle-powered lantern, an incandescent lamp holder, or combinations thereof.

17. The device of claim 16, wherein the supported device is affixed to the post.

18. The device of claim 16, wherein the post is inserted into the post support collar.

19. The device of claim 16, wherein the post support collar is inserted into the interior vessel.

20. The device of claim 16, wherein the interior vessel is inserted into the exterior vessel.
